(19) United States
(12) Patent Application Publication
(10) Pub. No.: US 2009/0288539 A1
(43) Pub. Date: Nov. 26, 2009

(54) Knife Carrier Having Deactivatable Spring-Loading

(76) Inventors: Rudolf Supe-Dienes, Overath (DE); Falk Oberhoff, Reichshaf (DE)

Correspondence Address: ROBERT W. BECKER & ASSOCIATES, 707 HIGHWAY 333, SUITE B, TIJERAS, NM, 87059-7507, US

(21) Appl. No.: 12/468,771

(22) Filed: May 19, 2009

(30) Foreign Application Priority Data
May 20, 2008 (DE) 10 2008 024361.2

(51) Int. Cl. B26D 1/14

(52) U.S. Cl. 83/508.2

(57) ABSTRACT

A longitudinal cutting or slitting machine having a knife carrier that supports a circular knife. A pre-tensioning element is disposed on the knife carrier for pre-tensioning the circular knife into a cutting position defined by abutment of the circular knife against a counterknife. A changeover mechanism is disposed on the knife carrier for placing the pre-tensioning element in an ineffective position that provides a firm connection between the knife carrier and the circular knife.

The instant application should be granted the priority date of May 20, 2008 the filing date of the corresponding German patent application 10 2008 024361.2.

### BACKGROUND OF THE INVENTION

The present invention relates to a longitudinal cutting or slitting machine having disposed thereon knife carriers for a circular knife respectively held thereon, whereby the circular knife is pre-tensioned or preloaded by a pre-tensioning element disposed on the knife carrier into its cutting position defined by abutment of the circular knife against a counterknife.

A knife carrier provided for a longitudinal cutting or slitting machine and having the aforementioned features is known from DE 202 01 744 U1. With the blade holder described in this document, the circular knife, which is mounted on a hub formed on the knife carrier, is pre-tensioned by a knife spring to rest against the counterknife, whereby the knife spring is comprised of two leaf springs that are placed against one another, are inserted on the hub, and are supported against the knife carrier.

To the extent that with a knife carrier embodied in this fashion the circular knife can respectively deflect against the effect of the knife spring, a construction of knife carriers is also known according to which the circular knife is disposed against the knife carrier in a fixed position and thus rests in an unmovable manner against a counterknife. Such a knife carrier Is described, for example, in EP 0 113 668 A1, according to which the circular knife is fixedly clamped against the knife carrier.

To the extent that operational situations exist in which one or the other manner of operation of the circular knife is expedient, it is an object of the present invention to configure a longitudinal cutting or slitting machines having a knife carrier of the aforementioned general type in such a way that it is possible to have both the manner of operation where the circular knife is under pre-tension, in particular being spring-loaded, as well as the manner of operation where the circular knife is fixed or secured in position.

### BRIEF DESCRIPTION OF THE DRAWINGS

This object, and other objects and advantages of the present invention, will appear more clearly from the following specification in conjunction with the accompanying schematic drawings, in which:

FIG. 1 is a partially cross-sectioned side view showing a portion of a knife carrier with a circular knife held thereon;

FIGS. 2a & 2b are partial views of the subject matter of FIG. 1 showing the two functional positions of the changeover mechanism,

FIG. 3 shows a further embodiment of the knife carrier of FIG. 1,

FIGS. 4a & 4b show a further embodiment of the knife carrier of FIG. 1 with, as a changeover mechanism, a split annular nut, which enables a variable adjustment of the spring force, in the two functional positions with an activated knife spring and with a knife spring that is tensioned to a block, i.e. a deactivated knife spring,

FIGS. 5a and 5b show an alternative embodiment to the embodiment illustrated in FIGS. 4a and 4b of a knife carrier having a differently embodied knife spring, and

FIGS. 6a and 6b show an embodiment of the knife carrier with a changeover mechanism embodied as a pressure distribution ring in the two functional positions of FIGS. 4a and 4b.

### SUMMARY OF THE INVENTION

The basic concept of the present invention is that by means of a changeover mechanism disposed on the knife carrier, the pre-tensioning element can be placed in an ineffective position that provides a firm connection between the knife carrier and the circular knife. The longitudinal cutting machine of the present application has the advantage that the construction of the knife carrier permits both manners of operation with a circular knife that is under pre-tension or pre-load as well as with a circular knife that is fixed in position, and it is merely necessary to activate a single changeover mechanism that is configured on the knife carrier in order to selectively shift back and forth between the two manners of operation.

Pursuant to one embodiment of the invention, the installed changeover mechanism can also be used to realize a variable adjustment or setting of the pre-tension that acts upon the circular knife. For this purpose, by means of the changeover mechanism, with the pre-tensioning element made to be effective by the changeover mechanism, a variable adjustment of the pre-tensioning force of the pre-tensioning element is provided.

Pursuant to a first embodiment of the invention, the pre-tensioning element is embodied as a knife spring that is supported against the knife carrier and pretensions the circular knife into its cutting position. Further embodiments of the invention are directed either to activating the effect of the installed knife spring, or to entirely deactivate it, or to make the spring force exerted by the knife spring variably adjustable.

With regard to an activation and deactivation of the knife spring, pursuant to a first embodiment of the invention disposed on the knife carrier is at least one axially displaceable fixation pin that acts upon the circular knife, with the knife spring that is supported against the knife carrier pressing the fixation pin in its spring-loading position under pre-tension against the circular knife, whereby the changeover mechanism is configured for the fixing of the fixation pin in position in its stationary secured position against the knife carrier. This solution thus proceeds from the holding of the circular knife against the knife carrier by means of at least one fixation pin that is axially displaceable in the knife carrier, whereby the axial displaceability of the fixation pin that is under spring effect on the one hand enables the manner of operation with a spring-loaded circular knife, whereas the fixation pin that is stationarily fixed in position by means of the changeover mechanism in its secured position brings about the manner of operation with a circular knife that is secured in position on the knife carrier.

To realize this principle, the circular knife can be mounted on a hub formed on the knife carrier, and fixation pin, knife spring as well as changeover mechanism can be disposed on an annular nut that is disposed on the hub. In detail, this provides that fixation pin and knife spring are disposed on that side of the circular knife facing away from the counterknife, and disposed on the knife carrier, as the changeover mechanism, is a rotatable apertured plate that in its one position is aligned with the fixation pin via an opening formed on the apertured plate, and in its other position rests against the fixation pin and fixes it in position.

In an alternative embodiment, a circular knife is mounted on a hub formed on the knife carrier and is held against the knife carrier by the fixation pin, which is held on the knife carrier and is disposed on that side of the circular knife associated with the counterknife, whereby in its spring-loading position, the fixation pin is displaceable against the effect of the knife spring disposed in the knife carrier, and in its secured position is adapted to be fixed in position by means of the changeover mechanism that is disposed on the knife carrier.

In this connection, the fixation pin can be connected with a lock nut that is displaceably disposed in a recessed portion disposed in the knife carrier, and the lock nut can be pre-tensioned by the knife spring disposed in the recessed portion into a position that effects the spring-loaded abutment of the fixation pin against the circular knife, whereby pursuant to one embodiment of the invention, the changeover mechanism is embodied as an orifice plate that fixes the position of the lock nut in a stationary position of the fixation pin with fixed abutment against the circular knife. Pursuant to one embodiment, the orifice plate can be rotatably disposed on the knife carrier and can engage the lock nut by means of an extension that extends into the recessed portion of the knife carrier.

If pursuant to one embodiment of the invention the knife spring is embodied as a pre-tensioned helical compression spring that is supported between the knife carrier and the fixation pin, the arrangement of a helical compression spring that surrounds the respective fixation pin enables a reduction in construction relative to the leaf spring arrangement that is conventional in the art.

Pursuant to one embodiment of the invention, for symmetry reasons a plurality of fixation pins are disposed on the knife carrier and are distributed over the periphery of the circular knife.

A variable adjustment of the respectively acting spring force of the knife spring, up to its entire deactivation, can be realized pursuant to an embodiment of the invention if the circular knife is mounted on a hub formed on the knife carrier and is secured by means of an annular nut disposed on the hub, whereby the changeover mechanism is integrated into the annular nut. In particular, the annular nut can be divided by a plane of separation into two annular nut sections that are movable relative to one another in such a way that a rotation of the annular nut sections relative to one another brings about an axial displacement of one of the annular nut sections along with an axial enlargement of the width of the annular nut. By means of this alteration of the axial overall width of the annular nut, an adjustment of the spring force proceeding from the knife spring is ultimately possible.

Pursuant to embodiments of the invention, for this purpose the plane of separation formed on the annular nut can be configured as an inclined plane that extends in the axial direction between the annular nut sections. Alternatively, the plane of separation that is formed on the annular nut can be configured with a contour that is wave shaped in the peripheral direction and in the axial direction of the annular nut forms wave peaks and wave troughs. In both cases, when the annular nut sections rotate relative to one another, the two annular nut sections run against one another along their plane of separation, leading to the axial displacement of one of the two sections.

With regard to the configuration of the knife spring, pursuant to one embodiment of the invention the knife spring is embodied as a set of springs that includes at least two leaf springs that are placed against one another and are disposed on a hub, and that is disposed between the annular nut and the circular knife, whereby the pre-tensioning force of the set of springs can be variably adjustable by axial displacement of the annular nut sections.

Also within the scope of such an arrangement with an appropriately split annular nut, an embodiment of the invention can be provided where the knife spring can be activated or even entirely deactivated. In this connection, the knife spring is embodied as a cord spring that sits on an inclined plate that is disposed on the knife carrier and is inclined in the direction of the circular knife, whereby the annular nut section that faces the circular knife, when it is displaced axially, passes via a shoulder into abutment against the circular knife and fixes the circular knife in position.

Alternatively, for the configuration of the pre-tension element as a mechanically operating spring, pursuant to an embodiment of the invention the pre-tensioning element is embodied as a pressure distribution ring that is disposed on a knife carrier and has a plurality of axially movable pistons that are distributed over its periphery and are intended for abutment against the circular knife; the pistons are connected to a uniform pressure chamber for a fluid that is to be introduced therein. Such a pressure distribution ring is known, for example, from DE 10232772 B3.

If the pressure of the fluid present in the pressure chamber of the pressure distribution ring is variably adjustable by means of the associated changeover mechanism, then on the one hand the pressure in the pressure chamber of the pressure distribution ring can be set to such a value that during the cutting operation a circular knife that deflects against the action of the pistons presses the pistons into the pressure distribution ring until the pressure set in the pressure chamber is reached. If the pressure in the pressure chamber in the pressure distribution ring is set so high that a pressing-in of the pistons by the circular knife is no longer possible, the manner of operation is configured for a circular knife that is fixed in position.

Pursuant to a modified embodiment, the pre-tensioning element can be embodied as an inflatable hose that is disposed on the knife carrier and that is supported between the circular knife and an abutment disposed on the knife carrier. In this connection, the support against the circular knife can be realized directly by abutment of the hose against the circular knife, or indirectly via the interposition of a suitable component. Also with this embodiment it is possible, by regulating the inflation hardness of the hose, to set the pressure in the hose in such a way that on the one hand during the cutting operation the circular knife deflects to the desired extent, and on the other hand the circular knife is fixed in position by a hose that is inflated to an appropriately hard extent.

It is possible to employ the present invention with all types of knife carriers, and in particular with a knife carrier that is part of a knife head provided on a knife holder disposed on the longitudinal cutting or slitting machine, or, alternatively, with a knife carrier that is a jacket or box disposed on the longitudinal cutting or slitting machine. However, the aforementioned examples of application do not limit the realization of the invention in a technical regard.

Further specific features of the present application will be described in detail subsequently.

### DESCRIPTION OF SPECIFIC EMBODIMENTS

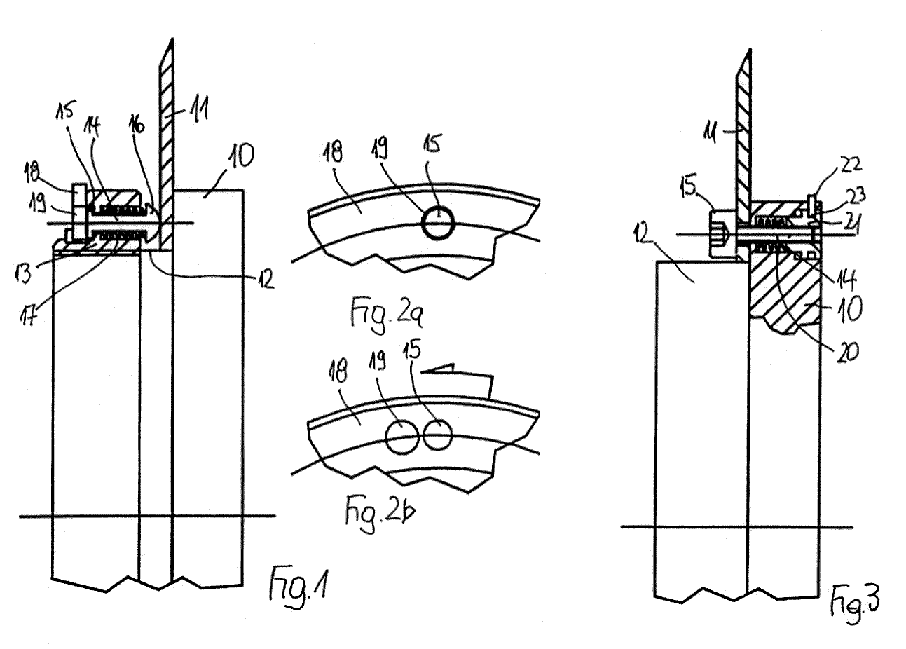

Referring first to FIGS. 1 to 3, illustrated is an embodiment of the present invention according to which an activation or deactivation of the spring force of a knife spring that acts on a circular knife is provided.

As can be seen from FIG. 1, a circular knife or blade 11 is rotatably mounted on a knife or blade carrier 10 on a hub 12 that is formed on the knife carrier 10. On its side that faces away from the non-illustrated counterknife, the circular knife 11 is secured in position by means of fixation pins 14 that are disposed on an annular nut 13 that is threaded onto the knife carrier 10; only one of the fixation pins 14 is illustrated in FIG. 1. For this purpose, the fixation pin 14 is displaceably mounted in the annular nut 13, whereby a front abutment head 16 of the fixation pin 14 rests against the circular knife 11. A head 15 is also formed on that side of the fixation pin 14 that faces away from its front abutment head 16. By means of a pre-tensioned compression spring 17, which is supported between the annular nut 13, as a component of the knife carrier 10, and the abutment head 16 of the fixation pin 14, the fixation pin is pressed so as to rest against the circular knife 11.

On the rear side of the annular nut 13 that faces away from the circular knife 11, an apertured plate 18 is rotatably mounted on the annular nut 13. The apertured plate 18 has an opening 19 that is disposed in such a way that in one position of rotation of the apertured plate 18 the opening 19 is in an aligned position with the fixation pin 14 in which the head 15 of the fixation pin can pass through the opening 19 as illustrated in FIG. 2a. In the other position of the apertured plate 18, which is rotated relative to the position of FIG. 2a, and which is illustrated in FIG. 2b, the opening 19 is rotated relative to the fixation pin 14, so that the apertured plate 18 rests against the head 15 of the fixation pin 14 and thus prevents axial movement of the fixation pin.

Thus, if the apertured plate 18 is in a position in which its opening 19 is aligned with the head 15 of the fixation pin 14, as illustrated in FIG. 2a, an axial movement of the fixation pin 14 against the action of the compression spring 17 is possible. Thus, if during a cutting operation a circular knife 11 experiences an axial loading, the circular knife can deflect in the direction of annular nut 13 against the spring effect of the compression spring 17; this is accomplished by displacement of the fixation pin 14 that is displaceably disposed in the annular nut 13. Thus, an operating state with an elastic or spring-loaded circular knife 11 is established.

However, if the apertured plate 18 is in a position of rotation in which the opening 19 is rotated relative to the fixation pin 14, as illustrated in FIG. 2b, the apertured plate 18 rests against the head 15 of the fixation pin 14 and thus fixes the fixation pin in a position in which the front abutment head 16 thereof is pressed permanently against the circular knife 11 and secures it axially in a non-displaceable or fixed position. Thus, an operating state with a circular knife that is fixed in position is realized. A shifting between the two above-described operating states is enabled merely by rotating the apertured plate 18.

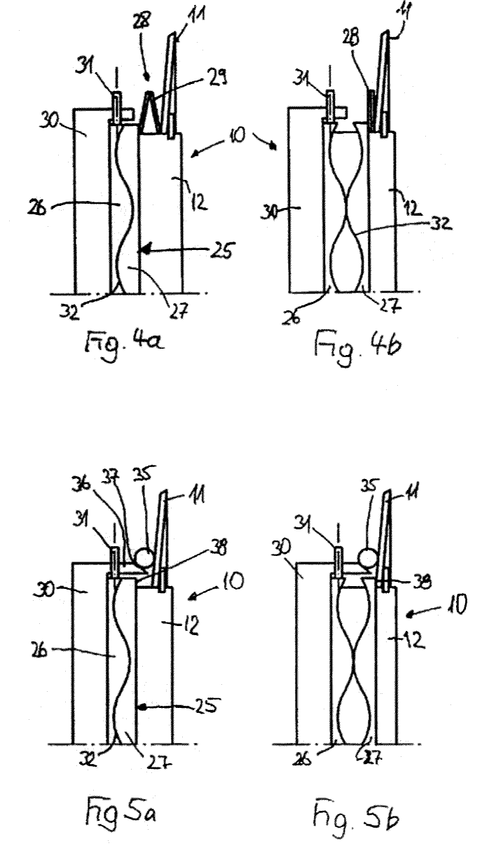

FIG. 3 shows a modified embodiment of the present invention; in this embodiment, the fixation pin 14 is disposed on the same side as is the counterknife. This has the advantage of a narrower overall axial width. For this purpose, a recessed portion 20 is disposed in the knife carrier 10, which forms the abutment surface for the circular knife 11; the fixation pin 14 is displaceable in the recessed portion 20. The fixation pin 14, which extends through the circular knife 11, is provided on that side that faces away from the non-illustrated counterknife with the head 15, by means of which the circular knife 11 is pressed against the abutment surface of the knife carrier 10. Disposed within the recessed portion 20 is a counternut or lock nut 21, which is associated or connected with the pertaining end of the fixation pin 14. Furthermore disposed in the recessed portion 20 is a compression spring 17 that is supported between the knife carrier 10 and the lock nut 21. In addition, rotatably disposed on the knife carrier 10 is an orifice plate 22, an extension 23 of which engages the lock nut 21 and, depending upon its position of rotation, either fixes the position of the lock nut in the recessed portion 20 in a non-displaceable manner, or permits displacement thereof.

If the extension 23 of the orifice plate 22 is not in engagement with the lock nut 21, the fixation pin 14 with its head 15, and the lock nut 21, are displaceable in the recessed portion 20 against the effect of the compression spring 17. If in such a manner of operation the circular knife 11 experiences a loading during a cutting operation due to the non-illustrated counterknife, the circular knife 11 can deflect due to the axial displacement of the fixation pin 14, which corresponds to the operating state with the spring-loaded circular knife.

If the extension 23 of the orifice plate 22 is in engagement with the lock nut 21, and hence the lock nut is fixed in position in the recessed portion 20 in an unmovable manner, the axial movement of the fixation pin 14 in the recessed portion 20 is also blocked, so that the head 15 of the fixation pin 14 rests against the circular knife 11 in an unmovable manner and hence securely holds the circular knife between the head 15 and the blade carrier 10. This corresponds to the manner of operation with the circular knife fixed in position.

With the embodiment illustrated in FIGS. 4a and 4b, the circular knife 11 that is disposed on the hub 12 is pre-tensioned or preloaded by a set of springs 28 that is placed on the hub 12 and is comprised of two leaf or flat springs 29, as knife springs, that are placed against one another, whereby the set of springs 28 is supported between the circular knife 11 and an annular nut 25 that is threaded onto the hub 12. By means of a plane of separation 32, the annular nut 25 is divided into two annular nut sections 26 and 27, which are displaceable relative to one another as can be seen from a comparison of FIGS. 4a and 4b. The plane of separation 32 has a wave-like configuration with wave peaks and wave troughs formed in the axial direction of the annular nut 25, so that a rotation of the two annular nut sections 26, 27 relative to one another results in a running up of the wave peaks on one another, as a consequence of which the overall axial width of the annular nut 25 increases. As can be seen from FIG. 4b, with the maximum spreading of the two annular nut sections 26 and 27 relative to one another, the set of springs 28 is tensioned to a block form, and in this position a deflection of the circular knife 11 is no longer possible. Thus, the manner of operation with a fixedly held circular knife is provided. It is to be understood that in the intermediate positions between the operating states illustrated in FIGS. 4a and 4b, respectively different pre-tensioning of the set of springs 28 is established. For this purpose, the annular nut section 27 is provided with a handle extension 31 for the rotation of these annular nut sections. For the rotation, the annular nut section 26 is supported against an abutment 40 that is formed on the knife carrier 10.

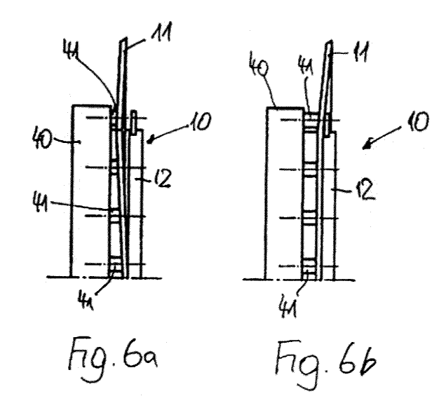

The embodiment illustrated in FIGS. 5a and 5b differs from the previously described embodiment of FIGS. 4a and 4b in that without a variable adjustment of the spring force of the knife spring, the circular knife can be secured in position by the changeover mechanism integrated in the annular nut 25, so that the knife spring is deactivated. With this embodiment, the knife spring is in the form of a round cord spring 35, which on the one hand rests against the circular knife 11 and on the other hand is supported against an inclined plane 37 disposed on a projecting arm 36 of the knife carrier 10. Such a spring arrangement is known in the art for producing a pre-tension with such knife carriers. If the circular knife 11 deflects during a cutting operation, the circular knife displaces the cord spring 35 along the inclined plane 37, so that the cord spring 35 is tensioned and the spring force that acts upon the circular knife 11 is increased. With such an embodiment, a shoulder 38 is disposed on the annular nut section 27, which is displaceable on the hub 12, whereby, as described in conjunction with the embodiment of FIGS. 4a and 4b, when the annular nut sections 26, 27 are spread apart, the shoulder 38 of the annular nut section 27 comes to rest against the circular knife 11 and fixes it in position in an unmovable manner. In so doing, the effect of the cord spring 35 as a knife spring is bypassed, so that the force of the knife spring is deactivated.

With the embodiment illustrated in FIGS. 6a and 6b, again a variable adjustment of the pre-tensioning force exerted by the pre-tensioning element is possible. For this purpose, disposed on the knife carrier 10 is a pressure distribution ring 40 in which is formed a pressure chamber for a fluid that is to be introduced therein. Connected to this pressure chamber are a plurality of axially movable pistons 41 that are distributed over the periphery of the pressure distribution ring 40; the pistons 41 are configured for resting against the circular knife 11. As can be seen from FIG. 6a, the pressure in the pressure chamber of the pressure distribution ring 40 can be adjusted such that in a cutting operation, a deflection of the circular knife 11 is possible in that the circular knife presses against the pistons 41 that act upon it more or less until the pressure established in the pressure chamber in the pressure distribution ring 40 is reached. If the pressure in the pressure chamber of the pressure distribution ring 40 is set so high that a pressing-in of the pistons 41 by the force exerted by the circular knife 11 is no longer possible, then in conformity with the illustration of FIG. 6b the circular knife 11 is unmovably fixed in position by the pistons 41 so that the pre-tensioning element in the form of the pressure distribution ring 40 is without effect.

The features of the subject matter disclosed in the preceding specification, the claims, the abstract and the drawings can be important individually as well as in any desired combination with one another for realizing the various embodiments of the invention.

The specification incorporates by reference the disclosure of German priority document 10 2008 024361.2 filed May 20, 2008.

The present invention is, of course, in no way restricted to the specific disclosure of the specification and drawings, but also encompasses any modifications within the scope of the appended claims.

What I claim is:

1. A longitudinal cutting or slitting machine, comprising:
a knife carrier that supports a circular knife;
a pre-tensioning element disposed on said knife carrier for pre-tensioning said circular knife into a cutting position defined by abutment of said circular knife against a counterknife; and
a changeover mechanism disposed on said knife carrier for placing said pre-tensioning element in an ineffective position that provides a firm connection between said knife carrier and said circular knife.

2. A longitudinal cutting or slitting machine according to claim 1, wherein when said pre-tensioning element is made effective by said changeover mechanism, said changeover mechanism is adapted to provide a variable adjustment of a pre-tensioning force of said pre-tensioning element.

3. A longitudinal cutting or slitting machine according to claim 1, wherein said pre-tensioning element is embodied as a knife spring that is supported against the knife carrier and pre-tensions said circular knife into a cutting position.

4. A longitudinal cutting or slitting machine according to claim 3, wherein at least one axially displaceable fixation pin that acts upon said circular knife is disposed on said knife carrier, wherein said knife spring is supported on said knife carrier and presses said at least one fixation pin, in its spring-loading position, against said circular knife under pre-tension, and wherein for fixing said at least one fixation pin in position in a stationary secured position, said changeover mechanism is provided on said knife carrier.

5. A longitudinal cutting or slitting machine according to claim 4, wherein a hub is formed on said knife carrier, wherein said circular knife is mounted on said hub, wherein an annular nut is disposed on said hub, and wherein said at least one fixation pin, said knife spring and said changeover mechanism are disposed on said annular nut.

6. A longitudinal cutting or slitting machine according to claim 5, wherein said at least one fixation pin and said knife spring are disposed on a side of said circular knife that faces away from the counterknife, wherein said changeover mechanism is a rotatable apertured plate that is disposed on said knife carrier, wherein in a first position of said apertured plate an opening of said apertured plate is aligned with said at least one fixation pin, and wherein in a second position said apertured plate rests against at least one fixation pin and fixes said fixation pin in position.

7. A longitudinal cutting or slitting machine according to claim 4, wherein a hub is formed on said knife carrier, wherein said circular knife is mounted on said hub, wherein said at least one fixation pin is held on said knife carrier on a side of said circular knife that is associated with the counterknife, wherein said circular knife is held against said knife carrier by said at least one fixation pin, wherein in its spring-loading position said at least one fixation pin is displaceable against the effect of said knife spring, which is disposed in said knife carrier and wherein in its secured position said at least one fixation pin (14) is adapted to be fixed in position by means of said changeover mechanism, which is disposed on said knife carrier.

8. A longitudinal cutting or slitting machine according to claim 7, wherein a lock nut is displaceably disposed in a recessed portion disposed in said knife carrier, wherein said at least one fixation pin is adapted to be connected to said lock nut wherein said knife spring is disposed in said recessed portion, and wherein said lock nut is adapted to be pre-tensioned into a position that effects a spring-loaded abutment of said at least one fixation pin against said circular knife.

9. A longitudinal cutting or slitting machine according to claim 8, wherein said changeover mechanism is embodied as an orifice plate that fixes said lock nut in position in a stationary position of said at least one fixation pin with fixed abutment against said circular knife.

10. A longitudinal cutting or slitting machine according to claim 9, wherein said orifice plate is rotatably disposed on said knife carrier and is provided with an extension that extends into said recessed portion of said knife carrier, and wherein said extension of said orifice plate is adapted to engage said lock nut.

11. A longitudinal cutting or slitting machine according to claim 4, wherein said knife spring is embodied as a pre-tensioned helical compression spring that is supported between said knife carrier and said at least one fixation pin.

12. A longitudinal cutting or slitting machine according to claim 4, wherein a plurality of fixation pins are disposed on said knife carrier distributed over the periphery of said circular knife.

13. A longitudinal cutting or slitting machine according to claim 3, wherein a hub is formed on said knife carrier, wherein an annular nut is disposed on said hub, wherein said circular knife is mounted on said hub, and is secured via said annular nut, and wherein said changeover mechanism is integrated into said annular nut.

14. A longitudinal cutting or slitting machine according to claim 13, wherein said annular nut is divided by a plane of separation into two annular nut sections that are movable relative to one another such that a rotation of said annular nut sections relative to one another brings about an axial displacement of one of said annular nut sections along with an axial enlargement of a width of said annular nut.

15. A longitudinal cutting or slitting machine according to claim 14, wherein said plane of separation formed on said annular nut is configured as an inclined plane that extends in a generally axial direction between said annular nut sections.

16. A longitudinal cutting or slitting machine according to claim 14, wherein said plane of separation formed on said annular nut is configured with a contour that is wave-shaped in a peripheral direction and in an axial direction of said annular nut forms wave peaks and wave troughs.

17. A longitudinal cutting or slitting machine according to claim 13, wherein said knife spring is embodied as a set of springs that includes at least two leaf springs disposed on said hub and placed against one another, wherein said set of springs is disposed between said annular nut and said circular knife.

18. A longitudinal cutting or slitting machine according to claim 17, wherein a pre-tensioning force of said set of springs is variably adjustable by axial displacement of at least one of said annular nut sections.

19. A longitudinal cutting or slitting machine according to claim 14, wherein said knife spring is embodied as a cord spring that is seated on an inclined plane that is disposed on said knife carrier and is inclined in a direction toward circular knife, wherein a one of said annular nut sections that faces said circular knife is provided with a shoulder, and wherein upon axial displacement of said one annular nut section said shoulder thereof comes into abutment against said circular knife and fixes said circular knife in position.

20. A longitudinal cutting or slitting machine according to claim 1, wherein said pre-tensioning element is embodied as a pressure distribution ring that is disposed on said knife carrier, wherein said pressure distribution ring is provided with a plurality of axially movable pistons distributed over the periphery of said pressure distribution ring for abutment against said circular knife, and wherein said pistons are connected to a uniform pressure chamber for a fluid that is adapted to be introduced therein.

21. A longitudinal cutting or slitting machine according to claim 20, wherein fluid pressure present in said pressure chamber of said pressure distribution ring is variably adjustable by means of said changeover mechanism.

22. A longitudinal cutting or slitting machine according to claim 1, wherein said pre-tensioning element is embodied as an inflatable hose that is disposed on said knife carrier, and wherein said inflatable hose is supported between said circular knife and an abutment disposed on said knife carrier.

23. A longitudinal cutting or slitting machine according to claim 1, wherein said knife carrier is part of a knife head provided on a knife holder disposed on said longitudinal cutting or slitting machine, or wherein said knife carrier is a jacket or box disposed on said longitudinal cutting or slitting machine.
